(19) United States
(12) Patent Application Publication
(10) Pub. No.: US 2026/0099234 A1
(43) Pub. Date: Apr. 9, 2026

(54) TECHNIQUES FOR EXTRACTING INFORMATION FROM GRAPHICAL OBJECTS

(71) Applicant: Lenovo (United States) Inc., Morrisville, NC (US)

(72) Inventors: Scott Li, Cary, NC (US); Rod D Waltermann, Rougemont, NC (US); Igor Stolbikov, Apex, NC (US); Sergei Rodionov, Plano, TX (US); Javier Guillermo, Dallas, TX (US)

(21) Appl. No.: 18/908,650

(22) Filed: Oct. 7, 2024

(51) Int. Cl. G06F 3/04815; G06F 3/04817; G06F 3/0486

(52) U.S. Cl. CPC G06F 3/04815; G06F 3/04817; G06F 3/0486

(57) ABSTRACT

Apparatuses, method, systems, and program products are disclosed for techniques for extracting information from graphical objects. A method includes detecting an interaction event associated with a first graphical object or a second graphical object. The first and second graphical objects are displayed on a display device. The method includes extracting a set of information associated with the second graphical object and sending the set of information associated with the second graphical object to an AI/ML model. The method includes receiving, from the AI/ML model, a response that is generated based on the set of information associated with the second graphical object.

### FIELD

The subject matter disclosed herein relates to graphical objects and more particularly relates to techniques for extracting information from graphical objects.

### BACKGROUND

Using an artificial intelligence (“AI”) engine often requires manual operations, such as copying and pasting data from an application, a window, a file, an image, or the like, into a chatbot interface associated with an artificial intelligence/machine learning (“AI/ML”) model. The context switch between a primary application and the chatbot interface introduces friction and cognitive overhead. Moreover, the AI's understanding of intent and the relevant context is limited by the information explicitly provided through text or captured media.

### BRIEF SUMMARY

A method for techniques for extracting information from graphical objects (e.g., desktop objects) is disclosed. An apparatus and computer program product also perform the functions of the method. The method includes detecting an interaction event associated with a first graphical object or a second graphical object. The first and second graphical objects are displayed on a display device. The method includes extracting a set of information associated with the second graphical object and sending the set of information associated with the second graphical object to an AI/ML model. The method includes receiving, from the AI/ML model, a response that is generated based on the set of information associated with the second graphical object.

According to another aspect of the present disclosure, an apparatus for techniques for extracting information from graphical objects (e.g., desktop objects) is disclosed. The apparatus may include a processor and non-transitory computer readable storage media storing code. The code may be executable by the processor to perform operations that include detecting an interaction event associated with a first graphical object or a second graphical object. The first and second graphical objects are displayed on a display device. The operations include extracting a set of information associated with the second graphical object and sending the set of information associated with the second graphical object to an AI/ML model. The operations include receiving, from the AI/ML model, a response that is generated based on the set of information associated with the second graphical object.

According to another aspect of the present disclosure, a program product for techniques for extracting information from graphical objects (e.g., desktop objects) is disclosed. The program product may include a non-transitory computer readable storage media storing code. The code may be configured to be executable by a processor to perform operations that include detecting an interaction event associated with a first graphical object or a second graphical object. The first and second graphical objects are displayed on a display device. The operations include extracting a set of information associated with the second graphical object and sending the set of information associated with the second graphical object to an AI/ML model. The operations include receiving, from the AI/ML model, a response that is generated based on the set of information associated with the second graphical object.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system for techniques for extracting information from graphical objects, according to various embodiments;

FIG. 2 is a schematic block diagram illustrating an apparatus for techniques for extracting information from graphical objects, according to various embodiments;

FIG. 3 is a schematic block diagram illustrating another apparatus for techniques for extracting information from graphical objects, according to various embodiments;

FIG. 4 is an example block diagram illustrating an embodiment of a first graphical object dragged and dropped onto a second graphical object;

FIG. 5 is a schematic block diagram illustrating a method for techniques for extracting information from graphical objects, according to various embodiments; and

FIG. 6 is a schematic flow chart diagram illustrating another method for techniques for extracting information from graphical objects, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system. ” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

A method for techniques for extracting information from graphical objects (e.g., desktop objects) is disclosed. An apparatus and computer program product also perform the functions of the method. The method includes detecting an interaction event associated with a first graphical object or a second graphical object. The first and second graphical objects are displayed on a display device. The method includes extracting a set of information associated with the second graphical object and sending the set of information associated with the second graphical object to an AI/ML model. The method includes receiving, from the AI/ML model, a response that is generated based on the set of information associated with the second graphical object.

In some embodiments, the first graphical object is an AI assistant icon. In some embodiments, extracting the set of information includes extracting contextual information of the second graphical object and content of the second graphical object.

In some embodiments, the interaction event of the first graphical object includes dragging and/or dropping the first graphical object onto the second graphical object and vice versa and in some embodiments, the first graphical object is configured to be draggable and droppable based on one or more user inputs.

In some embodiments, the method includes determining a type of the second graphical object. In some embodiments, the set of information is extracted based on the type of the second graphical object. In some embodiments, the type of the second graphical object may be, an application window, a file, a document, an image, a browser tab, or a pop-up window. In some embodiments, the method includes selecting a set of instructions to extract the set of information based on the type of the second graphical object.

In some embodiments, the method includes packaging the set of information associated with the second graphical object into a structured format for sending to the AI/ML model. In some embodiments, the structured format of the set of information associated with the second graphical object is suitable for input to the AI/ML model.

In some embodiments, the method includes generating a third graphical object on the display device in response to receiving the response from the AI/ML model and in some embodiments, the third graphical object is configured to display the response received from the AI/ML model. In some embodiments, the third graphical object may be an AI assistant window, a pop-up window, or an overlay. In some embodiments, the third graphical object includes an input field for receiving one or more prompts for the AI/ML model, wherein the one or more prompts are inputs to the AI/ML model. In some embodiments, the AI/ML model includes a large language model (“LLM”), a generative AI, and/or a computer vision model.

According to another aspect of the present disclosure, an apparatus for techniques for extracting information from graphical objects (e.g., desktop objects) is disclosed. The apparatus may include a processor and non-transitory computer readable storage media storing code. The code may be executable by the processor to perform operations that include detecting an interaction event associated with a first graphical object or a second graphical object. The first and second graphical objects are displayed on a display device. The operations include extracting a set of information associated with the second graphical object and sending the set of information associated with the second graphical object to an AI/ML model. The operations include receiving, from the AI/ML model, a response that is generated based on the set of information associated with the second graphical object.

In some embodiments, the first graphical object is an AI assistant icon. In some embodiments, extracting the set of information includes extracting contextual information of the second graphical object and content of the second graphical object.

In some embodiments, the interaction event of the first graphical object includes dragging and/or dropping the first graphical object onto the second graphical object and vice versa and in some embodiments, the first graphical object is configured to be draggable and droppable based on one or more user inputs.

In some embodiments, the operations include determining a type of the second graphical object. In some embodiments, the set of information is extracted based on the type of the second graphical object. In some embodiments, the type of the second graphical object may be, an application window, a file, a document, an image, a browser tab, or a pop-up window. In some embodiments, the operations include selecting a set of instructions to extract the set of information based on the type of the second graphical object.

In some embodiments, the operations include packaging the set of information associated with the second graphical object into a structured format for sending to the AI/ML model. In some embodiments, the structured format of the set of information associated with the second graphical object is suitable for input to the AI/ML model.

In some embodiments, the operations include generating a third graphical object on the display device in response to receiving the response from the AI/ML model and in some embodiments, the third graphical object is configured to display the response received from the AI/ML model. In some embodiments, the third graphical object may be an AI assistant window, a pop-up window, or an overlay. In some embodiments, the third graphical object includes an input field for receiving one or more prompts for the AI/ML model, wherein the one or more prompts are inputs to the AI/ML model. In some embodiments, the AI/ML model includes an LLM, a generative AI, and/or a computer vision model.

According to another aspect of the present disclosure, a program product for techniques for extracting information from graphical objects (e.g., desktop objects) is disclosed. The program product may include a non-transitory computer readable storage media storing code. The code may be configured to be executable by a processor to perform operations that include detecting an interaction event associated with a first graphical object or a second graphical object. The first and second graphical objects are displayed on a display device. The operations include extracting a set of information associated with the second graphical object and sending the set of information associated with the second graphical object to an AI/ML model. The operations include receiving, from the AI/ML model, a response that is generated based on the set of information associated with the second graphical object.

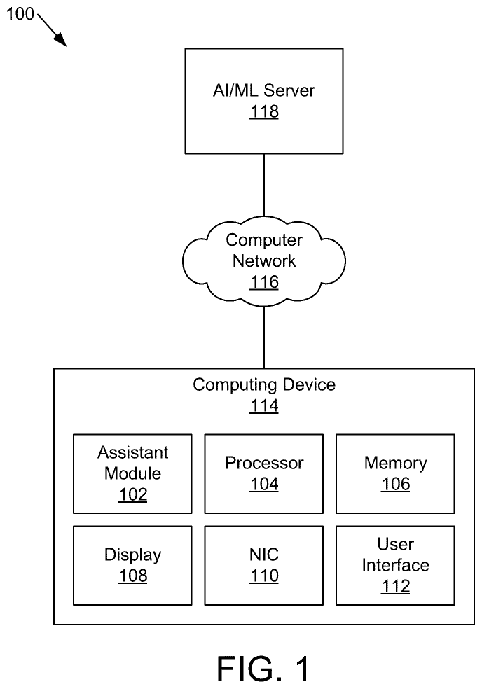

FIG. 1 is a schematic block diagram illustrating a system 100 for techniques for extracting information from graphical objects, according to various embodiments. The system 100 includes an assistant module 102, a processor 104, a memory 106, a display 108, network interface cards (“NICs”) 110, a user interface 112, a computing device 114, a computer network 116, an AI/ML server 118.

Use of an AI engine may require manual copying and pasting operations for data from an application, a window, a file, an image, or the like, into a chatbot interface associated with an AI/ML model. The context switch between a primary application and the chatbot interface introduces friction and cognitive overhead. Moreover, the AI's understanding of intent and the relevant context is limited by the information explicitly provided through text or captured media.

The assistant module 102, in one embodiment, enables integration of an AI/ML model with applications, windows, files, images, or the like. The assistant module 102, in one embodiment, provides the user with a first graphical object such as an icon, a widget, a graphic symbol, or the like, in a graphical user environment, such as a desktop environment, a virtual reality environment, an augmented reality environment, a mixed reality environment, or the like, which acts as an AI assistant to the user. In some embodiments, the first graphical object may be an AI assistant icon.

The assistant module 102, in some embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the assistant module 102 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the assistant module 102.

The semiconductor integrated circuit device or other hardware appliance of the assistant module 102, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the assistant module 102 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

In some embodiments, the assistant module 102 detects an interaction event associated with the first graphical or a second graphical object. In some embodiments, the first graphical object and the second graphical objects may be a first desktop object and a second desktop object which are displayed on the computing device 114. In general, a desktop object may refer to any item, element, or entity that appears on the desktop of a computer system's graphical user interface. The second graphical object may be, for example, but not limited to an application, a window, a file, or an image. In some embodiments, the second graphical object, may include a view area. In one embodiments, the first and second graphical objects are displayed on a computing device 114. The computing device 114 may be, for example, but not limited to a desktop, a laptop, a tab, or a mobile phone. In some embodiments, the interaction event may include dragging, moving, dropping, and/or placing the first graphical object onto the second graphical object.

In some embodiments, the assistant module 102, in response to detecting the interaction event, extracts a set of information associated with the second graphical object. In some embodiments, the set of information may include contextual information of the second graphical object and a content of the second graphical object.

In some embodiments, the assistant module 102 sends the set of information associated with the second graphical object to an AI/ML model and receives, from the AI/ML model, a response that is generated based on the set of information associated with the second graphical object. In general, an ML model is a type of mathematical model that can be used to make predictions or classifications on new data after being trained on a given dataset. In general, an AI model, is a program that uses data sets to identify patterns and make predictions. AI models are trained on data to perform specific tasks, such as making decisions or recognizing patterns, without the need for further human intervention.

In some embodiments, the AI/ML model may include an LLM, a generative AI, and/or a computer vision model. In general an LLM is a type of artificial intelligence program that can recognize and generate text, among other tasks. A generative AI is a machine learning model that creates new data, such as images, text, video, or audio, that is similar to the data it was trained on. A computer vision model is a software program that analyzes images and videos to interpret and understand visual data.

In some embodiments, the assistant module 102, prior to sending the set of information to the AI/ML model, may package the set of information into a structured format which is suitable for input to the AI/ML model. In some embodiments, the assistant module 102, may generate a third graphical object, such as an AI assistant window, a pop-up window, a notification window, an overlay window, or the like, which is used to display the response that is received from the AI/ML model. In some embodiments, the overlay window may refer to a window that is displayed on the second graphical object.

The system 100 includes a computing device 114, that includes the assistant module 102, the processor 104 (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), the memory 106, the display 108, the NIC 110, and the user interface 112. The computing device 114 may be embodied as one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, head phones, or the like), a High-Definition Multimedia Interface (“HDMI”) or other electronic display dongle, a personal digital assistant, a digital camera, a video camera, or another computing device. The computing device 114 may further include, in general, one or more communication buses, one or more non-volatile memories, storage interfaces, etc. The computing device 114 may be connected to an AI/ML server 118 over a computer network 116.

In general, NIC 110 is a hardware component that allows a computer to connect to a network and communicate with other devices on the network. In general, the user interface 112 is a point of human-computer interaction and communication on a device, webpage, or application which includes display screens, keyboards, a mouse, etc.

The system 100 includes an AI/ML server 118 that may include one or more AI/ML models, for example, LLMs, generative AIs, computer vision models, etc. The AI/ML server 118, in general, may be a computer system that includes one or more AI/ML models, one or more processors, one or more memory storage devices, NICs, etc. In some embodiments, the AI/ML server 118 may be associated with a cloud-based AI.

The system 100 includes a computer network 116, that includes a LAN, a WAN, a fiber network, a wireless connection, the Internet, or the like. In some embodiments, the computer network 116 includes two or more networks. In some embodiments, the computer network 116 includes servers, wiring, switches, routers, etc.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM” ), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA” ). Alternatively, the wireless connection may be a cellular telephone network communication. All standards and/or connection types include the latest version and revision of the standard and/or connection type as of the filing date of this application.

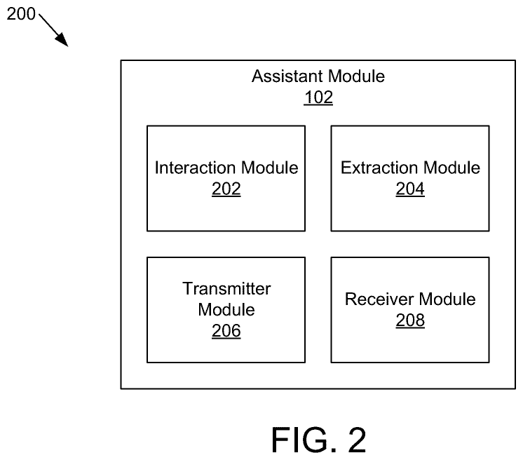

FIG. 2 is a schematic block diagram illustrating an apparatus 200 for techniques for extracting information from graphical objects, according to various embodiments. The apparatus 200 includes an assistant module 102 that includes an interaction module 202, an extraction module 204, a transmitter module 206, and a receiver module 208. In some embodiments, the apparatus 200 is implemented using executable code stored on a computer readable storage device, which is non-transitory. The code is executable on a processor. In other embodiments, all or a portion of the apparatus 200 is implemented using a programmable hardware device and/or hardware circuits.

The apparatus 200 includes an interaction module 202 configured to detect an interaction event associated with a first graphical object or a second graphical object. In some embodiments, the interaction event may be dragging and/or dropping the first graphical object onto the second graphical object. In some embodiments, the interaction event may include moving and/or placing the first graphical object onto the second graphical object. In some embodiments, the first graphical object may be an AI assistant icon. The AI assistant icon may be for example, an icon, a widget, a graphic symbol, etc. The second graphical object may be, for example, but not limited to an application, a window, a file, a document, an image, or a browser tab. In some embodiments, the second graphical object, may include a view area. In some embodiments, the first graphical object is configured to be draggable, movable, droppable, and/or placeable based on one or more user inputs. In other embodiments, the interaction event may be dragging, moving, dropping, and/or placing the second graphical object onto the first graphical object.

For example, the interaction module 202 may enable the user to use a cursor (e.g., a visible and moving pointer, present on the display, that the user controls with a mouse, a touchpad, or a similar input device) to drag the first graphical object and/or drop the first graphical object onto the second graphical object. For example, the user may use a mouse, a touchpad, or a similar input device, to click or select the first graphical object, drag the first graphical object onto the second graphical object, and drop the first graphical object onto the second graphical object. In other embodiments, the interaction module may enable the user to drag and/or drop the second graphical object onto the first graphical object.

In some embodiments, prior to the user interaction with the first graphical object, the first graphical object may be displayed on the display 108 at one of the corners of the display 108, at one of the edges of the display 108, or at any other location on the display 108 that the user prefers. In some embodiments, the first graphical object may be an icon, a widget, a graphic symbol or any other graphic element which is customizable by the user.

The apparatus 200 includes an extraction module 204 configured to extract a set of information associated with the second graphical object. In some embodiments, the extraction module 204, may extract the set of information in response to detecting the interaction event. In some embodiments, extracting the set of information may include extracting contextual information of the second graphical object and the content of the second graphical object. In some embodiments, the extraction module 204 may use application programming interface (“API”) functions of an operating system, e.g., Microsoft Windows®, Apple iOS®, and/or the like, to extract the set of information associated with the second graphical object.

In general, API functions are a set of libraries that allow the assistant module 102 to interact with the operating system. The API functions may be exposed in dynamic-link libraries (“DLLs”) accessible via the operating system. In general, an API is an interface through which one program communicates with another program. It should be noted that the extraction module 204 may use any other functions that are specific to the operating system running on the computing device 114. The operating system may be, for example, macOS®, iOS®, Android®, Linux®, ChromeOS®, etc. or any other operating system that may arise in the future.

In some embodiments, the extraction module 204 may identify a target window of the second graphical object based on a cursor position (e.g., a specific location on the display 108) of the first graphical object. For example, when the user encounters a pop-up error message (e.g., the second graphical object), the user may drop the first graphical object onto the pop-up error message, and the extraction module 204 may identify the target window of the pop-up error message on the display 108 based on the cursor position of the first graphical object.

In some embodiments, the extraction module 204 may use, for example, ‘WindowFromPoint’ function to identify the target window or a window handle of the second graphical object. For example, when the first graphical object is dropped onto the pop-up error message, the ‘WindowFromPoint’ function identifies a window of the pop-up error message that is present under the first graphical object as the target window. If the second graphical object is dropped or placed on the first graphical object, the ‘WindowFromPoint’ function identifies the window handle of the pop-up error message. In general, a window handle is a unique number that identifies a window on the display 108. The operating system assigns a window handle to each window when it's created, and the handle remains the same as long as the window is open. When a window is closed, it gives up its handle, and if the window is created again, the operating system will assign a new handle.

In some embodiments, the extraction module 204 may extract the content associated with the second graphical object (e.g., the pop-up error message) by using ‘GetWindowText’ function of the API. In some embodiments, the extraction module 204 may extract one or more contextual information associated with the second graphical object (e.g., the pop-up error message) by using one or more other API functions. For example, the extraction module 204 may use ‘GetWindowThreadProcessId’ function to retrieve the process ID associated with the second graphical object. The process ID includes information regarding the application that generated the second graphical object. The extraction module may use ‘GetParent’ function enables the extraction module to traverse a window hierarchy and determine a parent application or process that spawned the second graphical object (e.g., the pop-up error message). With the process ID obtained from the ‘GetWindowThreadProcessId’ function, the extraction module 204 may gather additional information associated with the parent application by using functions such as ‘GetModuleFileNameEx’ and ‘GetProcessImageFileName’. The additional information may be for example, an executable file path, version details, and other metadata related to the parent application.

In some embodiments, the content associated with the second graphical object may refer to any data which is displayed on the second graphical object and that is visible to the user. In some embodiments, the contextual information may refer to any data which is not displayed on the second graphical object and that is not visible to the user.

In some embodiments, the extraction module 204 determines the type of the second graphical object in response to detecting the interaction event. In some embodiments, the extraction module 204 may use one or more other API functions such as ‘GetClassName’ and/or ‘GetWindowText’ to determine the type of the second graphical object. The types of the second graphical object may be an application window, a file, a document, an image, a browser tab, etc. In some embodiments, the type of the second graphical object, may be sent to the AI/ML server 118 as the contextual information associated with the second graphical object.

In some embodiments, the extraction module 204 selects a type of instruction (e.g., Windows API function or API calls) to be used to extract the set of information associated with the second graphical object, based on the type of the second graphical object. In some embodiments, the extraction module 204 selects a type of instruction (e.g., Windows API function or API calls) to be used to extract the content associated with the second graphical object, based on the type of the second graphical object. For example, if the type of the second graphical object is a Word document, then the extraction module 204 may use ‘Microsoft.Office.Interop.Word’ namespace to create an instance of a Word application, open the Word document, and retrieve its content. If the type of the second graphical object is an image, the extraction module 204 may use ‘PrintWindow’, or ‘BitBlt’ Windows API functions to capture content of the image. If the type of the second graphical object is a browser tab, the extraction module 204 may use ‘IWebBrowserApp’ interface from the ‘SHDocVw’0 namespace to interact with the browser tab and retrieve the HTML content of the browser tab. For other types of second graphical object, the extraction module 204 may use the ‘GetWindowText’ Windows API function to retrieve the content displayed in the window and/or other techniques like optical character recognition (“OC”) to extract the text from the second graphical object's graphical content.

The apparatus 200, in one embodiment, includes a transmitter module 206 configured to send the set of information which was extracted by the extraction module 204 to an AI/ML server 118. In some embodiments, the transmitter module may package the extracted set of information into a structured format prior to sending to the AI/ML server 118. In some embodiments, the structured format may be a format that is suitable for input to an AI/ML model. In some embodiments, packaging the set of extracted set of information may refer to collecting the set of information in a data package.

For example, the transmitter module 206 may use JavaScript Object Notation (“JSON”) to bring the extracted set of information into a structured format. In general, JSON is a lightweight data-interchange format which is easy for humans to read and write and easy for machines to parse and generate. The packaged data (e.g., the data package) includes the window handle, the type of the second graphical object, the content of the second graphical object, and other additional metadata (e.g., process ID, parent application details, executable file path, version details, etc.) associated with the second graphical object. The packaged data may include a machine-readable file (e.g., datapackage.json) that explains the structure and meaning of the data. In some embodiments, the transmitter module 206 may send the extracted set of information to the AI/ML model by using the ‘GetAIResponse’ method.

The apparatus 200 includes a receiver module 208 configured to receive from the AI/ML server 118, a response generated by the AI/ML model, based on the set of information associated with the second graphical object. In some embodiments, the response may be a contextually relevant response or a contextually relevant assistance from the AI/ML model. In some embodiments, the response generated by the AI/ML model may include, an explanation, a suggestion, a guidance, a recommendation, a summarization, an analysis, a scene description, and/or an insight based on the type of the second graphical object.

For example, for a pop-up error message, the response may include, an explanation of the error message and its potential causes based on the application and context, suggested troubleshooting steps or solutions to resolve the error, and/or additional guidance or recommendations based on the error context and the user's system configuration. For documents, for instance, the response may include a summarization, analysis, and/or recommendations based on the content of the document. For images, the response may be object description, scene description, product suggestions, travel destination, and/or image analysis insight based on the content of the image. For browser tabs, the response may be webpage summarization, content analysis, and/or relevant recommendations based on the webpage content. For other types of second graphical object, the response may be explanations, recommendations, and/or guidance based on the extracted content and contextual information.

In some embodiments, the receiver module may display the response received from the AI/ML server 118, on a third graphical object. The third graphical object may be for example, a dedicated window that may be referred to as an AI assistant window. In some embodiments, the third graphical objects may be a third desktop objects which is displayed on the computing device 114. In another example, the third graphical object may be a pop-up notification, or an overlay on the second graphical object.

In some embodiments, the assistant module 102 may communicate with a local AI/ML model provided in the computing device 114, instead of the AI/ML server 118. For example, if the computing device 114 is Lenovo's AI PC which includes one or more AI engine, then the assistant module 102 may send the extracted set of information to the AI engine and receive a response based on the extracted set of information from the AI engine. In some embodiments, the receiver module 208 may present the AI/ML model's response to the user by using the ‘DisplayAIResponse’ method.

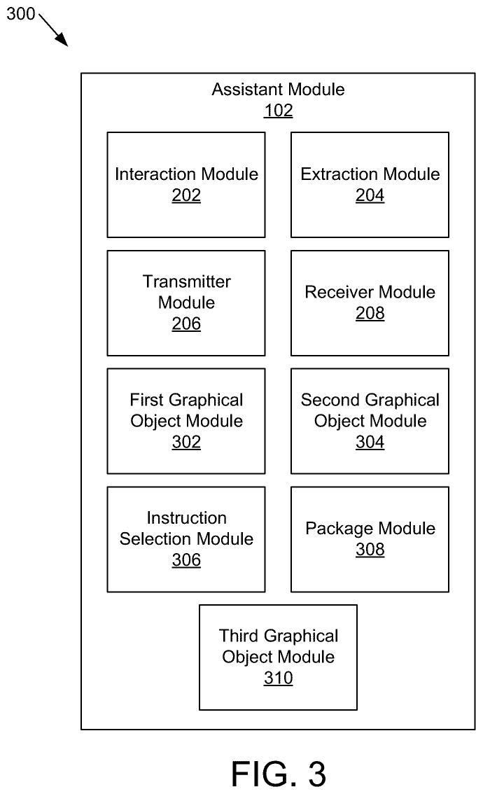

FIG. 3 is a schematic block diagram illustrating another apparatus 300 for techniques for extracting information from graphical objects (e.g., desktop objects), according to various embodiments. The apparatus 300 includes the assistant module 102 that includes an interaction module 202, an extraction module 204, a transmitter module 206, and a receiver module 208 which are substantially similar to those described above in relation the apparatus 200 of FIG. 2. In the implementation shown in FIG. 3, the assistant module 102 may include, in various embodiments, one or more of a first graphical object module 302, a second graphical object module 304, an instruction selection module 306, a package module 308, a third graphical object module 310, or any combination thereof. In various embodiments, all or a portion of the apparatus 300 is implemented similar to the apparatus 200 of FIG. 2.

The apparatus 300, in one embodiment, includes a first graphical object module 302 configured to present the first graphical object to the user on the display 108 of the computing device 114. In some embodiments, the first graphical object is an AI assistant icon. The AI assistant icon may be, for example, an icon, a widget, or a graphic symbol. In some embodiments, the first graphical object module 302 may enable the user to customize appearance, size, and/or name of the first graphical object based on the user's preference. In some embodiments, the first graphical object module 302 may include a user interface (“UI”) component. A UI component, in general, is a distinct element or module within a graphical user interface (“GUI”) that serves a specific function or displays certain content (e.g., the first graphical object). A GUI, in general refers to a form of user interface that allows users to interact with electronic devices (e.g., computing device 114) through graphical icons and visual indicators.

The apparatus 300, in one embodiment, includes a second graphical object module 304 configured to determine the type of the second graphical object. In some embodiments the determination of the type of the second graphical object may be an input to the extraction module 204. In some embodiments, the second graphical object module may use API functions such as ‘GetClassName’ and/or ‘GetWindowText’ to determine the type of the second graphical object. The second graphical object may be of various types such as, a document, an image viewer, a browser window, or the like. In some embodiments, the type of the second graphical object, may be sent to the AI/ML server 118 as the contextual information associated with the second graphical object.

The apparatus 300, in one embodiment, includes an instruction selection module 306 configured to select a type of a set of instructions that needs to be used to retrieve the content and the contextual information associated with the second graphical object based on the type of the second graphical object determined by the second graphical object module 304. For example, if the second graphical object is a Microsoft Word document, the instruction selection module 306, may select ‘Microsoft.Office.Interop.Word’ namespace to create an instance of a Word application, open the Word document, and retrieve its content. If the second graphical object is an image, the instruction selection module 306 may select ‘PrintWindow’, or ‘BitBlt’ Windows API functions to capture content of the image. If the second graphical object is a browser tab, the instruction selection module 306 may select ‘IWebBrowserApp’ interface from the ‘SHDocVw’ namespace to interact with the browser tab and retrieve the HTML content of the browser tab. For other types of second graphical object, the instruction selection module 306 may in general select the ‘GetWindowText’ Windows API function to retrieve the content displayed in the window and/or other techniques like optical character recognition (“OCR”) to extract the text from the second graphical object's graphical content. In some embodiments, the instruction selection module 306 may provide the type of the set of instructions to be used, or the set of instructions to the extraction module.

The apparatus 300 includes a package module 308 configured to package the extracted set of information in a structured format. In some embodiments, the package module 308 may use one or more formatting techniques (e.g., JSON) to bring the extracted set of information into a structured format. For example, the package module 308 may pack the extracted set of information into a JSON object to be input to the AI/ML model. In some embodiments, the package module 308 may use any other formatting techniques that may arise in the future to bring the extracted set of information into a structured format. In some embodiments, the package module 308 may bring the extracted set of information into a format that is suitable for input to an AI/ML model.

The apparatus 300 includes a third graphical object module 310 configured to generate a third graphical object on the display 108 in response to receiving a response from the AI/ML server 118 and display (e.g., present) the response received from the AI/ML server 118. In some embodiments, the third graphical objects may be a third desktop objects which is displayed on the computing device 114.

The third graphical object may be, for example, an AI assistant window, a pop-up notification or an overlay. In some embodiments, the third graphical object may be a dedicated window that may be referred to as an AI assistant window. In some embodiments the dedicated window may be customized based on appearance, size, etc. as preferred by the user. In some embodiments, the third graphical object module 310 may include another UI component to display the third graphical object.

In some embodiments, the third graphical object module 310 may be configured to provide an input field on the third graphical object to receive one or more prompts for the AI/ML model. In some embodiments, the prompts may be a follow up questions, or clarifications, or any other questions that the user may have for the AI/ML model. In some embodiments, the third graphical object module 310 may include a chatbot interface that enables to the user to communicate with the AI/ML model (e.g., sending follow-up questions and receiving other responses related to the follow-up question). In some embodiments, the input field may be associated with the chatbot interface.

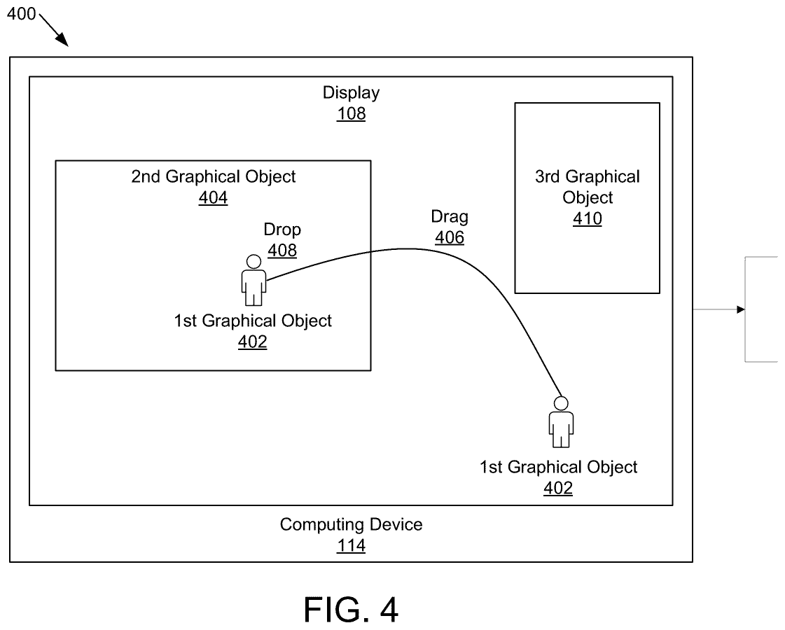

FIG. 4 is an example block diagram illustrating an embodiment of a first graphical object 402 dragged 406 and dropped 408 onto a second graphical object 404. In some embodiments, the computing device 114 includes the display 108 which displays a first graphical object 402, a second graphical object 404, and a third graphical object 410. The computing device 114 may be, for example, but not limited to a desktop, a laptop, a tab, or a mobile phone. The first graphical object 402 may be, for example, an icon, a widget, a graphic symbol, or the like. The second graphical object 404 may be, for example, but not limited to an application, a window, a file, or an image.

As shown in FIG. 4, a user drags 406 and drops 408 the first graphical object 402 onto the second graphical object 404 by using an input device (not shown) such as a mouse, a trackpad, a touchscreen, a joystick, etc. In some embodiments, dragging 406 and dropping 408 the first graphical object 402 onto the second graphical object 404 may refer to the interaction event. In some embodiments, in response to the user dragging 406 and dropping 408 the first graphical object 402 onto the second graphical object 404, the third graphical object 410 appears on the display 108. In some embodiments, the third graphical object 410 may be, for example an AI assistant window, a pop-up window, an overlay, etc. In some embodiments, the third graphical object 410 may include an input field (not shown) which enables the user to input prompts to the AI/ML model.

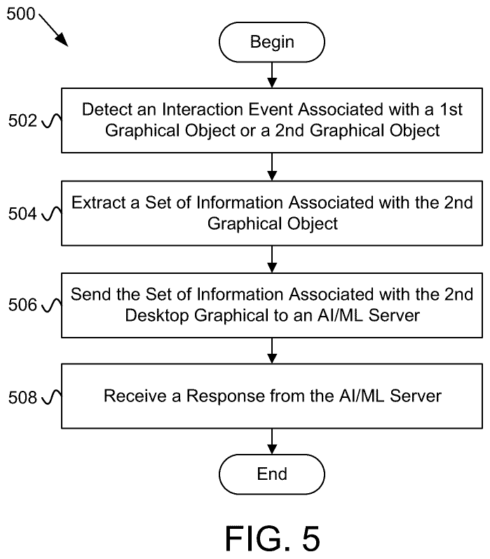

FIG. 5 is a schematic block diagram illustrating a method 500 for techniques for extracting information from graphical objects (e.g., desktop objects), according to various embodiments. In one embodiment, the assistant module 102, the interaction module 202, the extraction module 204, the transmitter module 206, and/or the receiver module 208 perform the various steps of the method 500.

In some embodiments, the method 500 begins and detects 502 an interaction event associated with a first graphical object or a second graphical object. In some embodiments, the first and second graphical objects are displayed on a computing device 114. In some embodiments the method 500, extracts 504 a set of information associated with the second graphical object and sends 506 the set of information associated with the second graphical object to an AI/ML server 118. In some embodiments, the method 500 receives 508, from the AI/ML server 118, a response that is generated by an AI/ML model based on the set of information associated with the second graphical object and the method 500 ends.

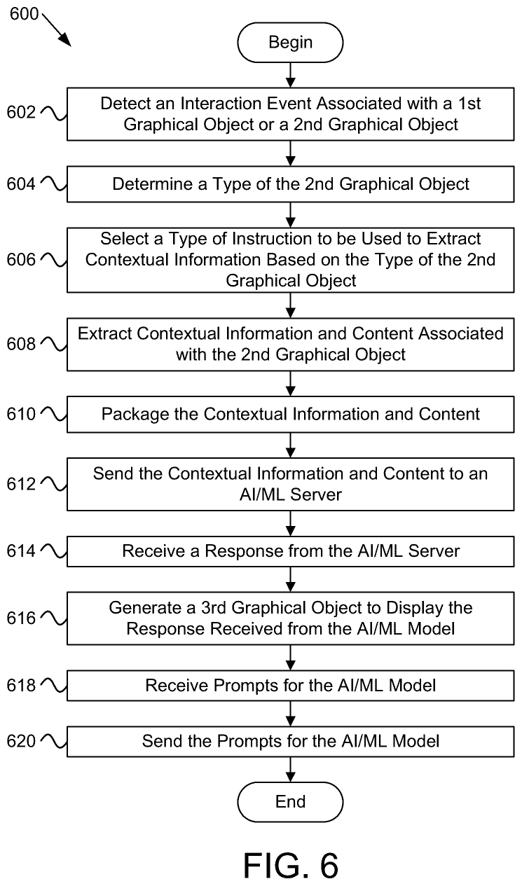

FIG. 6 is a schematic flow chart diagram illustrating another method 600 for techniques for extracting information from graphical objects (e.g., desktop objects), according to various embodiments. In one embodiment, the assistant module 102, the interaction module 202, the extraction module 204, the transmitter module 206, the receiver module 208, the first graphical object module 302, the second graphical object module 304, the instruction selection module 306, the package module 308 and/or the third graphical object module 310 perform the various steps of the method 600. In some embodiments, the method 600 begins and detects 602 an interaction event associated with a first graphical object or a second graphical object. In some embodiments, the first and second graphical objects are displayed on a computing device 114. In some embodiments, the method 500, determines 604, a type of the second graphical object displayed on the display device. In some embodiments, the method 600 selects 606, a type of a set of instructions to be used for extraction, based on the type of the second graphical object. In some embodiments, the method 600, extracts 608, contextual information associated with the second graphical object and a content associated with the second graphical object.

In some embodiments, the method 600, packages 610, the contextual information associated with the second graphical object and the content associated with the second graphical object. In some embodiments, the method 600, sends 612, the contextual information associated with the second graphical object and the content associated with the second graphical object to an AI/ML server 118. In some embodiments, the method 600, receives 614 a response, from the AI/ML server, which is generated based on the contextual information associated with the second graphical object and the content associated with the second graphical object.

In some embodiments, the method 600, generates 616 generating a third graphical object on the display device in response to receiving the response from the AI/ML server 118. In some embodiments, the third graphical object is configured to display the response received from the AI/ML server 118. In some embodiments, the method 600, receives 618, in an input field, one or more prompts for the AI/ML server 118 and sends 620, the one or more prompts to the AI/ML server 118. In some embodiments, the AI/ML server 118 may respond to the one or more prompts that were input to the AI/ML server 118, and the method 600 ends.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
detecting an interaction event associated with a first graphical object or a second graphical object, wherein the first and second graphical objects are displayed on a display device;
extracting a set of information associated with the second graphical object;
sending the set of information associated with the second graphical object to an artificial intelligence/machine learning (“AI/ML”) model; and
receiving, from the AI/ML model, a response that is generated based on the set of information associated with the second graphical object.

2. The method of claim 1, wherein the first graphical object is an artificial intelligence (“AI”) assistant icon.

3. The method of claim 1, wherein extracting the set of information comprises extracting contextual information of the second graphical object and content of the second graphical object.

4. The method of claim 1, wherein the interaction event of the first graphical object comprises dragging and/or dropping the first graphical object onto the second graphical object and vice versa, and wherein the first graphical object is configured to be draggable and droppable based on one or more user inputs.

5. The method of claim 1, further comprising determining a type of the second graphical object, wherein the set of information is extracted based on the type of the second graphical object, wherein the type of the second graphical object is selected from a group consisting of an application window, a file, a document, an image, a browser tab, and a pop-up window.

6. The method of claim 5, further comprising selecting a set of instructions to extract the set of information based on the type of the second graphical object.

7. The method of claim 1, further comprising packaging the set of information associated with the second graphical object into a structured format for sending to the AI/ML model, wherein the structured format of the set of information associated with the second graphical object is suitable for input to the AI/ML model.

8. The method of claim 1, further comprising generating a third graphical object on the display device in response to receiving the response from the AI/ML model, wherein the third graphical object is configured to display the response received from the AI/ML model, wherein the third graphical object comprises a type selected from a group consisting of an AI assistant window, a pop-up window, and an overlay.

9. The method of claim 8, wherein the third graphical object comprises an input field for receiving one or more prompts for the AI/ML model, wherein the one or more prompts are inputs to the AI/ML model.

10. The method of claim 1, wherein the AI/ML model comprises a large language model (“LLM”), a generative AI, and/or a computer vision model.

11. An apparatus comprising:
a processor; and
non-transitory computer readable storage media storing code, the code being executable by the processor to perform operations comprising:
detecting an interaction event associated with a first graphical object or a second graphical object, wherein the first and second graphical objects are displayed on a display device;
extracting a set of information associated with the second graphical object;
sending the set of information associated with the second graphical object to an artificial intelligence/machine learning (“AI/ML”) model; and
receiving, from the AI/ML model, a response that is generated based on the set of information associated with the second graphical object.

12. The apparatus of claim 11, wherein the first graphical object is an artificial intelligence (“AI”) assistant icon.

13. The apparatus of claim 11, wherein extracting the set of information comprises extracting contextual information of the second graphical object and content of the second graphical object.

14. The apparatus of claim 11, wherein the interaction event of the first graphical object comprises dragging and/or dropping the first graphical object onto the second graphical object and vice versa, and wherein the first graphical object is configured to be draggable and droppable based on one or more user inputs.

15. The apparatus of claim 11, the operations further comprising determining a type of the second graphical object, wherein the set of information is extracted based on the type of the second graphical object, wherein the type of the second graphical object is selected from a group consisting of an application window, a file, a document, an image, a browser tab, and a pop-up window.

16. The apparatus of claim 15, the operations further comprising selecting a set of instructions to extract the set of information based on the type of the second graphical object.

17. The apparatus of claim 11, the operations further comprising packaging the set of information associated with the second graphical object into a structured format for sending to the AI/ML model, wherein the structured format of the set of information associated with the second graphical object is suitable for input to the AI/ML model.

18. The apparatus of claim 11, the operations further comprising generating a third graphical object on the display device in response to receiving the response from the AI/ML model, wherein the third graphical object is configured to display the response received from the AI/ML model, wherein the third graphical object comprises a type selected from a group consisting of an AI assistant window, a pop-up window, and an overlay.

19. The apparatus of claim 18, wherein the third graphical object comprises an input field for receiving one or more prompts for the AI/ML model, wherein the one or more prompts are inputs to the AI/ML model.

20. A program product comprising a non-transitory computer readable storage medium storing code, the code being configured to be executable by a processor to perform operations comprising:
detecting an interaction event associated with a first graphical object or a second graphical object, wherein the first and second graphical objects are displayed on a display device;
extracting a set of information associated with the second graphical object;
sending the set of information associated with the second graphical object to an artificial intelligence/machine learning (“AI/ML”) model; and
receiving, from the AI/ML model, a response that is generated based on the set of information associated with the second graphical object.
